(19) United States
(12) Patent Application Publication
(10) Pub. No.: US 2012/0076630 A1
(43) Pub. Date: Mar. 29, 2012

(54) Wind Turbine Component Handling Apparatus

(76) Inventor: Ashkan Vaziri Tehrani, Aarhus (DK)

(21) Appl. No.: 13/226,639

(22) Filed: Sep. 7, 2011

(30) Foreign Application Priority Data
Sep. 24, 2010 (EP) EP10179277

(51) Int. Cl. B65G 47/24

(52) U.S. Cl. 414/783; 414/816

(57) ABSTRACT

A wind turbine component handling apparatus with a docking device, a lifting device, and a turning device is provided. A method for turning a wind turbine component is also provided. A plurality of pins is mounted to the wind turbine component. The wind turbine component is positioned at a support apparatus such that each pin rests in a cradle element of the support apparatus. The docking device is pushed in the horizontal direction such that openings in the docking device engage the pins. The docking device is lifted, wherein the wind turbine component is lifted by the pins and the docking device is rotated about a horizontal axis, wherein the wind turbine component is rotated about the horizontal axis by the pins. Then, the docking device is lowered until the pins mounted to the wind turbine component rest in the cradle elements of the support apparatus.

### CROSS REFERENCE TO RELATED APPLICATIONS

This application claims priority of European Patent Application No. 10179277.8 EP filed Sep. 24, 2010, which is incorporated by reference herein in its entirety.

### FIELD OF INVENTION

The invention describes a wind turbine component handling apparatus and a corresponding method for use for manufacturing a wind turbine component. Particularly the invention relates to rotating the yaw bedplate during production of a wind turbine.

### BACKGROUND OF INVENTION

A standard wind turbine generally comprises a vertical tower supporting the nacelle. The nacelle supports a rotor having a horizontal rotation axis and a plurality of rotor blades. The nacelle can be rotated with respect to the tower by the so-called yaw drive about the vertical axis, which is also called yaw axis. The yaw drive is used to rotate the nacelle and thus the rotor such that the horizontal rotation axis of the rotor has the correct orientation with respect to the direction of the wind, i.e. the horizontal rotation axis of the rotor is generally essentially arranged parallel to the direction of the wind.

More information about the yaw system of a wind turbine is provided by Windkraftanlagen, Robert Gasch and Jochen Twele Eds., 6th edition 2010, Vieweg+Teubner.

It is to be understood that the yaw system has to support the weight of the nacelle and has to act against the pressure of the wind applied to the rotor. Thus, the yaw system and a bedplate of the yaw system have to accommodate high forces and these components are thus heavy and bulky.

During the manufacturing process of the wind turbine, components have to be mounted on both sides of the yaw bedplate. Since the bottom of the yaw bedplate is not fully accessible during manufacturing, the yaw bedplate has to be turned upside down. It is to be noted that such turning process has to comply with high safety standards due to the size and mass of the yaw bedplate.

In a prior art manufacturing process a crane is used to turn the bedplate. Jack rings are screwed to the bedplate. A crane hook is attached to the jack ring at one end of the bedplate. The bedplate is lifted on said one end into an upright position. On the opposite side of the first jack ring a second jack ring is attached, wherein the second crane hook engages the second jack ring. The second crane hook is used to turn the bedplate upside down. Thereafter, the yaw bedplate is lowered to its original position. Due to safety standards, this turning process requires considerable space. Moreover, this turning process requires an operator operating the cranes and attaching the hooks. Particularly, due to the attaching of the hooks and the operation of the crane, this turning process is time-consuming.

### SUMMARY OF INVENTION

It is an object of the claimed invention to provide an apparatus and a method for turning a wind turbine component which avoids the problems outlined above.

The object of the present invention is achieved by a wind turbine component handling apparatus and a method for handling a wind turbine component according to the claims.

The wind turbine component handling apparatus according to the invention is adapted to rotate a wind turbine component during manufacturing the wind turbine. The wind turbine component apparatus comprises a docking device that is realized to be movable essentially horizontally relative to the wind turbine component and to grip the wind turbine component. Gripping the wind turbine component can be interpreted as grasping, clamping, holding and the like. The wind turbine component handling apparatus further comprises a lifting device realized to essentially vertically lift the wind turbine component in the upward direction. The wind turbine component handling apparatus comprises a turning device adapted to rotate the wind turbine component essentially about a horizontal axis. The docking device may be moved pneumatically, hydraulically or by an electric motor to and from the wind turbine component. When the docking device is moved to the wind turbine component, the docking device may engage the wind turbine component and thus grip the wind turbine component. The lifting device may lift the wind turbine component in the vertical direction by a pneumatical, hydraulic or electric drive. Further, the turning device may comprise a hydraulic, pneumatic or electric drive in order to rotate the wind turbine component. After the wind turbine component handling apparatus has rotated the wind turbine component upside down, the wind turbine component may be lowered or lift down by the lifting device essentially to its original position and original vertical position, respectively.

Since the wind turbine component is held by the docking device, lifted up and turned upside down and lowered, the wind turbine component handling apparatus needs significantly less space as compared to handling the yaw bedplate by the crane. Further thereto, the wind turbine component is held by the docking device and accordingly the present invention offers a higher security as compared to turning the yaw bedplate upside down using the crane. Further, in an automatic operation mode the wind turbine component handling apparatus does not require any interaction with the operator when moving the docking device to the wind turbine component in order to grip the same, when vertically lifting the wind turbine component in the upward direction, when turning the wind turbine component about a horizontal axis and when lowering the wind turbine component to its original vertical position. However, in a semi-automatic or manual operation mode the operator may control the operation of the wind turbine handling apparatus. Accordingly, the wind turbine component handling apparatus is more efficient than a method using a crane for turning the yaw bedplate upside down. Further, the wind turbine component handling apparatus offers a higher level of security as compared to the above-mentioned use of a crane, since the wind turbine component is held by the docking device and thus cannot fall off the wind turbine component handling apparatus.

The docking device may engage the wind turbine component, such as by clamping, force closure, positive locking and the like. The wind turbine component may comprise features which are complementary with features provided at the docking device in order that the docking device may engage the wind turbine component. The features of the wind turbine component that engage the complementary features of the docking device may be releasably coupled with the wind turbine component during the production of the wind turbine, particularly for rotating the wind turbine component, such as a yaw bedplate.

Particularly advantageous embodiments and features of the invention are given by the dependent claims, as revealed in the following description.

The wind turbine component handling device may be controlled by a controller. The controller may instruct the docking device to move essentially horizontally to the wind turbine component in order to engage the wind turbine component. The controller may instruct the lifting device to lift the wind turbine component essentially vertically in the upward direction. Further, the controller may instruct the turning device to rotate the wind turbine component essentially about a horizontal axis.

Thus, the operation of the wind turbine component handling apparatus is controlled in an automatic operation mode by the controller and no operator interaction is needed for turning the wind turbine component. However, in a semi-automatic or manual operation mode the operator may control the operation of the wind turbine handling apparatus.

The docking device may be adapted to be positioned at opposite sides of the wind turbine component. The docking device may comprise two beams realized to be positioned at opposite sides of the wind turbine component, wherein each beam comprises at least one engaging portion adapted to engage a complementary engaging portion of the wind turbine component or of an auxiliary structure coupled to the wind turbine component. Since the beams grip the wind turbine component from opposite sides, the wind turbine component is held in a stable state. The wind turbine component may comprise a protrusion which engages the at least one opening of the beam. In the alternative, an auxiliary structure may be coupled to the wind turbine component that engages the at least one opening in the beam. The auxiliary structure coupled to the wind turbine component may be a pin which is screwed into the wind turbine component during manufacturing and which protrudes from the wind turbine component. The wind turbine component may comprise two openings at the first side and two openings at a second side opposite to the first side in which the pins are screwed. Each beam may comprise two openings that engage the respective pin screwed into the wind turbine component. Thereby, the wind turbine component can be held securely by the docking device.

The at least one opening may comprise an oval shape. Thereby, particularly position tolerances of the wind turbine component may be accommodated. The diameter of the opening may be larger than the diameter of the pin in order to ensure that the opening may by moved over the pin and in order to accommodate tolerances.

The turning device may be adapted to rotate the docking device and the wind turbine component coupled thereto about a horizontal axis. The turning device may rotate the beams and the wind turbine component coupled thereto about a horizontal axis. The lifting device may be realized to lift the docking device, such as the beams, and the wind turbine component coupled thereto in the vertical direction. The docking device, such as the beams, may be mounted on the turning device, and the turning device may be mounted on the lifting device.

As mentioned before, each beam may comprise at least two openings which are adapted to engage the pin coupled to the wind turbine component in order to grip the wind turbine component in a fixed position with respect to the docking device. Each beam may comprise at least one spacer, which is arranged on a wall of the beam that is directed to the wind turbine component. The spacer acts as a stop when the beam is moved in the horizontal direction to the wind turbine component. The spacer can ensure that the opening of the beam is positioned around the pin such that the pin is arranged in the opening. The spacer may comprise a sensor indicating that the spacer contacts the wind turbine component and thus indicating that the pin is positioned within the opening.

The invention also describes a wind turbine manufacturing system comprising the above-mentioned wind turbine component turning system and a support apparatus having at least one, preferably three or four, cradle or fork elements, wherein the auxiliary structure, i.e. preferably a pin, is positioned in a respective cradle or fork element and wherein each auxiliary structure is coupled with the wind turbine component. The wind turbine component may comprise openings in which the pins are screwed. The support apparatus may preferably comprise four cradle elements and preferably four pins are used, which are screwed preferably in two opposing sides of the wind turbine component. Thereby the wind turbine component is securely positioned in the support apparatus during manufacturing.

The support apparatus may be realized to be moved from one manufacturing station to the next manufacturing station. This allows that the same auxiliary structure, i.e. the pins, are used during a plurality of manufacturing steps. If the yaw bedplate is turned upside down using a crane in a state of the art method it is required to screw jack rings in the openings. However, the jack rings can only be used during turning the yaw bedplate by the crane, and cannot be used during other manufacturing steps.

The invention also describes a method of handling a wind turbine component comprising the following steps: gripping the wind turbine component by docking device, lifting the wind turbine component by a lifting device and rotating the wind turbine component by a turning device. The method may be perfoinied by the apparatus mentioned above. Rotating may include turning, tilting and/or flipping. Lifting the wind turbine component may include lifting up the wind turbine component from a support structure. After lifting the wind turbine component up and rotating the same, the wind turbine component may be lifted down to the support structure.

The method may comprise the following steps: mounting a plurality, preferably three or four, pins on the wind turbine component, positioning the wind turbine component on a support apparatus such that each pin rests in a cradle element of the support apparatus, and pushing a docking device essentially in the horizontal direction such that openings in the docking device engage the pins in the wind turbine component. The method further comprises the steps of essentially vertically lifting the docking device, wherein the wind turbine component is lifted by the pins mounted at the wind turbine component, and rotating the docking device essentially about a horizontal axis, wherein the wind turbine component is essentially turned about the horizontal axis by pins mounted at the wind turbine component. Finally, the docking device is lowered or lift down until the pins mounted at the wind turbine component rest in the respective one of the cradle elements of the support apparatus.

The method may comprise similar features as revealed above in the context with the yaw handling apparatus and the wind turbine manufacturing system.

The present invention is directed to an apparatus and a method of handling and/or rotating a wind turbine component. The wind turbine component may have a mass of preferably more than 10 kg, preferably more than 50 kg, more preferably more than 100 kg, more preferably more than 250 kg, more preferably more than 500 kg, most preferably more than 1000 kg. The wind turbine component may be part of the supporting structure of the wind turbine, in particular the yaw bedplate.

All objects and features of the present invention will become apparent from the following detailed description considered in conjunction with the accompanying drawings. It is to be understood, however that the drawings are designed solely for the purpose of illustration and not as a definition of the limits of the invention.

The invention will now be explained by an exemplary yaw turning apparatus. However, it is to be noted that the invention is not limited to a yaw turning apparatus, but can be applied for turning any component of a wind turbine.

### BRIEF DESCRIPTION OF THE DRAWINGS

FIG. 1 shows a perspective view of the yaw turning apparatus in its initial position;

FIG. 2 shows the yaw turning apparatus after a yaw bedplate has been moved to the yaw turning apparatus;

FIG. 3 shows the yaw turning apparatus after the docking device has been moved to the yaw bedplate;

FIG. 4 shows the yaw turning apparatus after lifting the yaw bedplate;

FIG. 5 shows the yaw turning apparatus during turning the yaw bedplate;

FIG. 6 shows the yaw turning apparatus after turning the yaw bedplate;

FIG. 7 shows the yaw turning apparatus after lowering the yaw bedplate;

FIG. 8 shows the yaw bedplate and views of a docking device;

FIG. 9 shows a beam in a detailed view;

FIG. 10 shows a detail of the beam;

FIG. 11 is a side view of the yaw bedplate arranged on a wagon;

FIGS. 12 and 13 show details of a cradle member of the wagon;

FIG. 14 shows the yaw bedplate and the beams during rotating the same; and

FIGS. 15 and 16 show details of the yaw bedplate and the beams during rotating the same.

### DETAILED DESCRIPTION OF INVENTION

In the drawings, like reference numerals refer to like objects throughout. Objects in the diagrams are not necessarily drawn to scale.

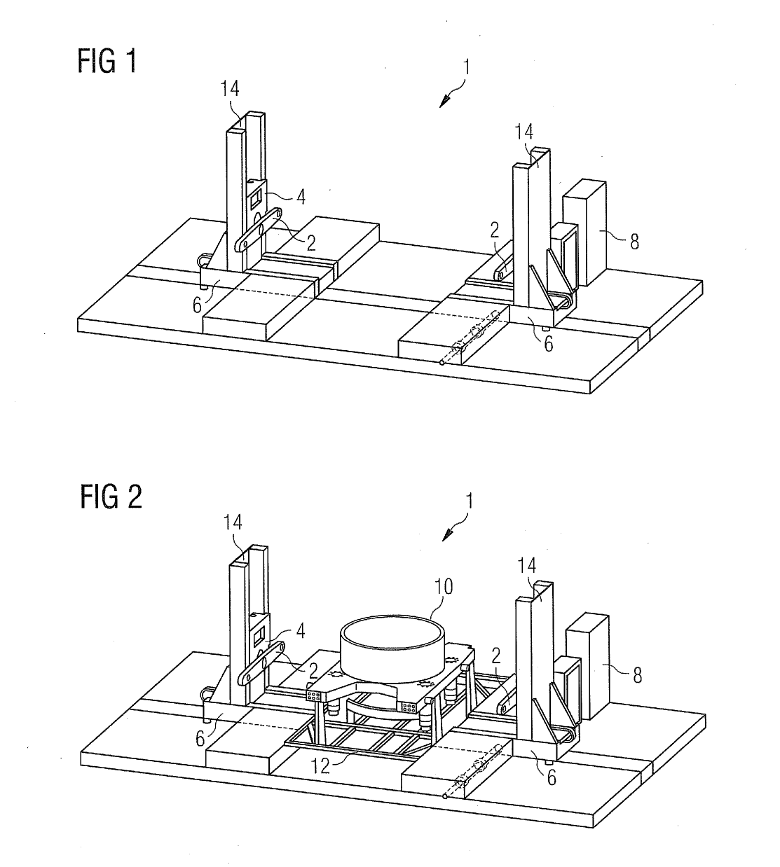

FIG. 1 shows a perspective view of a yaw turning apparatus 1. The yaw turning apparatus 1 comprises two carriages 6 that may be moved in the horizontal direction. On each carriage 6 a lifting device 14 is arranged. The lifting device 14 can lift, move, push etc. a turning device 4 in the vertical direction. On the turning device 4 a beam 2 is arranged.

The yaw turning apparatus 1 further comprises a control unit 8. The control unit 8 controls the operation of the carriages 6, the lifting devices 14 and the turning devices 4. The carriages 6, the lifting devices 14 and the turning devices 4 may be controlled and/or driven by hydraulic pressure, pneumatic pressure and/or electric current. Accordingly, the carriages 6, the lifting devices 14 and/or the turning devices 4 may comprise a hydraulic cylinder, a pneumatic cylinder and/or an electric motor. The person skilled in the art of industrial automation knows how to control these actors. For the sake of brevity, a detailed explanation of the control of the actors is therefore omitted.

FIG. 2 shows the yaw turning apparatus in such a state in which a yaw bedplate 10 arranged on a wagon 12 is positioned within the yaw turning apparatus 1. The first side of the yaw bedplate 10 is directed in the upward direction. Components may have been assembled on the first side of the yaw bedplate.

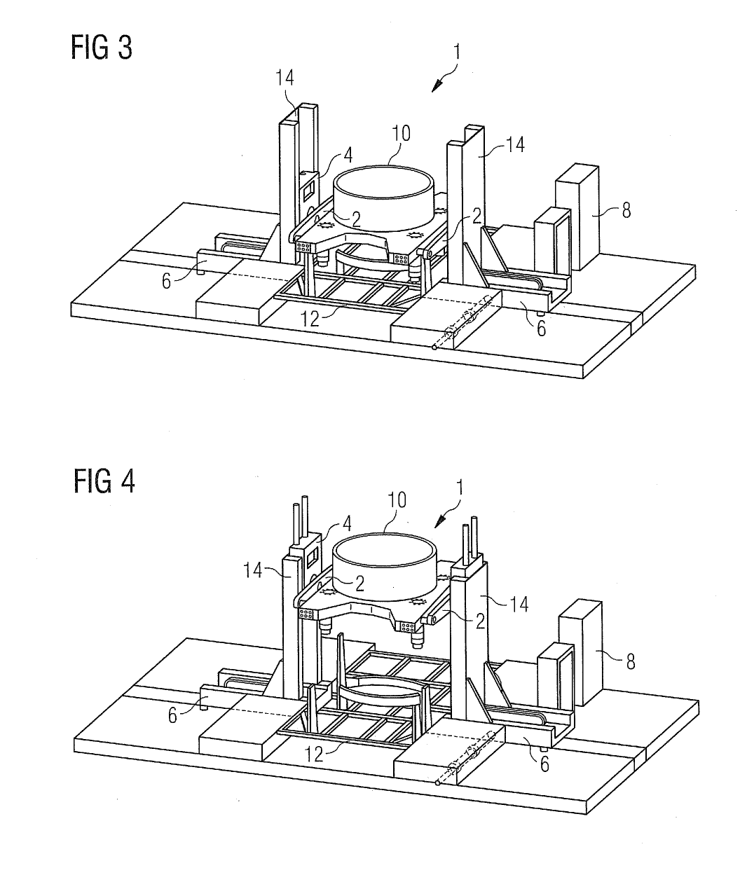

FIG. 3 shows the yaw handling apparatus 1 in a position, in which the beams 2 engage the yaw bedplate 10 after the carriages 6 have been moved horizontally to the yaw bedplate 10. In the described embodiment of the invention, the carriages 6 and/or the beams 2 foam the docking device. The yaw bedplate 10 is now held by the beams 2 being part of the docking device.

FIG. 4 shows the yaw handling apparatus 1 in a state after the lifting device 14 has lifted the yaw bedplate 10 upward in the vertical direction.

FIG. 5 shows a state in which the turning device 4 has turned the yaw bedplate 10 90° about a horizontal axis.

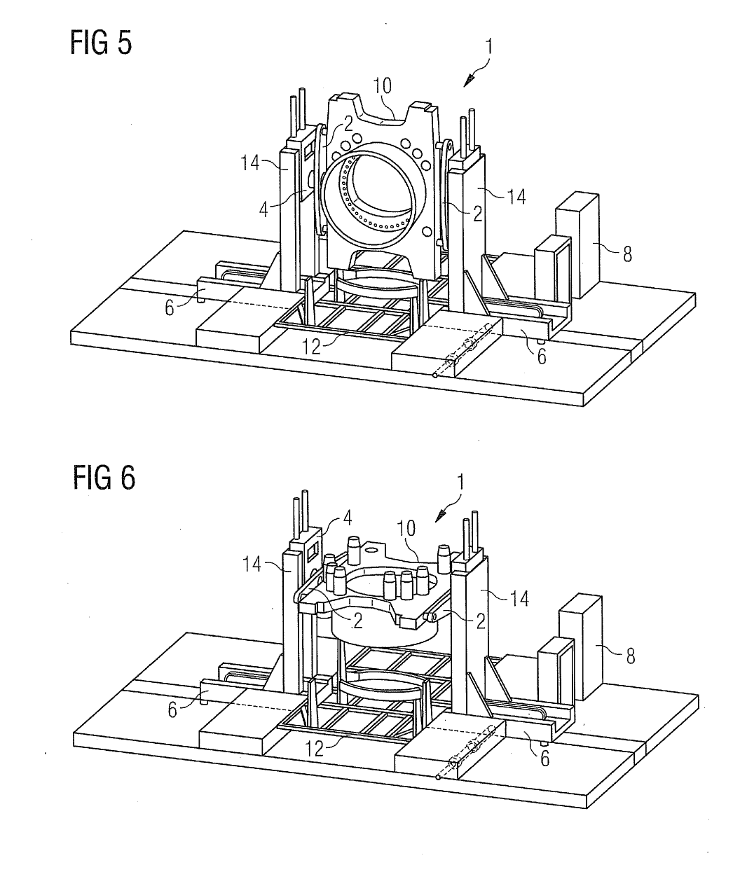

FIG. 6 shows the yaw handling apparatus 1 after the turning device 4 has turned the yaw bedplate 10 180° upside down. The second side of the yaw bedplate 10 faces upwards.

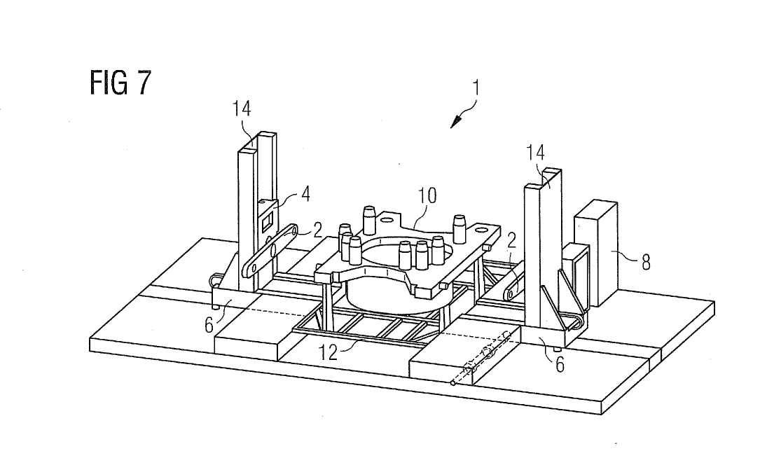

FIG. 7 shows the final state after the lifting devices 14 lowered or lift down the yaw bedplate 10 to the initial vertical position on the wagon 12. The carriages 6 and the beams 2, and thus the docking device have been withdrawn in the horizontal direction from the yaw bedplate 10.

The yaw bedplate has been turned upside down by the apparatus and method according to the present invention, and manufacturing may continue by assembling further components to the second side, which is now directed into the upward direction. It is to be understood that the yaw turning apparatus can rotate the yaw bedplate 10 in any orientation, i.e. after assembling the second side of the yaw bedplate. The yaw turning apparatus 1 may be used to bring the yaw bedplate 1 back in an orientation, in which the first side of the yaw bedplate faces in the upward direction.

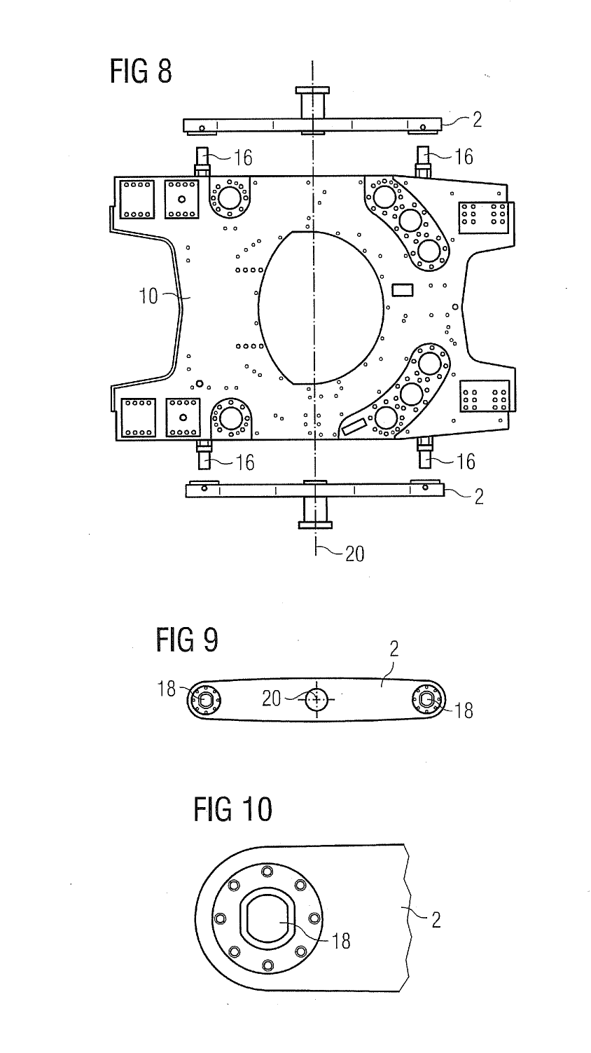

FIG. 8 shows details of the docking apparatus. Pins 16 are mounted, i.e. by screwing, on or into the yaw bedplate 10. The pins 16 are an auxiliary structure used during manufacturing and assembling the yaw bedplate. The pins minimize the pick-up and lay-down time of the yaw bedplate 10 from/into the wagon 12. The pins can also co-operate with a fork lift of a fork-lift truck in order to lift and transport the yaw bedplate during manufacturing. The pins 16 ensure that the yaw bedplate is accessible from both sides, since no support structure contacts the bedplate 10. The pins 16 can co-operate with any lifting equipment. The pins ensure that the bedplate is positioned in the wagon in a more or less reproducible position, as required for automation and moving the yaw bedplate in a production process. FIG. 8 also shows two beams 2, which are approaching the yaw bedplate in the horizontal direction in order to engage the pins 16. Preferably, the pins 16 are arranged symmetrical to the horizontal turning axis 20 of the turning devices.

FIG. 9 shows a side view of the beam 2. Preferably, two openings 18 are arranged symmetrically to the turning axis 20 of the beam.

FIG. 10 shows a further detail of the opening 18 of the beam 2. Preferably, the opening 18 has an oval shape in order to accommodate tolerances. The oval shape of the opening 18 may be formed such that the longer axis of the oval extends in the vertical or horizontal direction. One of the openings 18 of the beam 2 may be formed such that the longer axis of the oval extends in the vertical direction, whereas the other opening is formed such that the longer axis of the oval extends in the horizontal direction. Alternatively, both openings may be configured such that the longer axis of the oval extends in the vertical direction.

The openings 18 of the beams engage the pins 16, when the beam 2 is moved by a carriage 6 to the yaw bedplate 10. When the beam 2 engages the pins 16, one pin 16 is positioned in one of the openings 18, whereas the other pin 16 on the same side of the yaw bedplate 10 is positioned in the other opening 18 of the beam 2. In order to accommodate tolerances it is preferred that the opening 18 comprises a larger diameter than the pin 16.

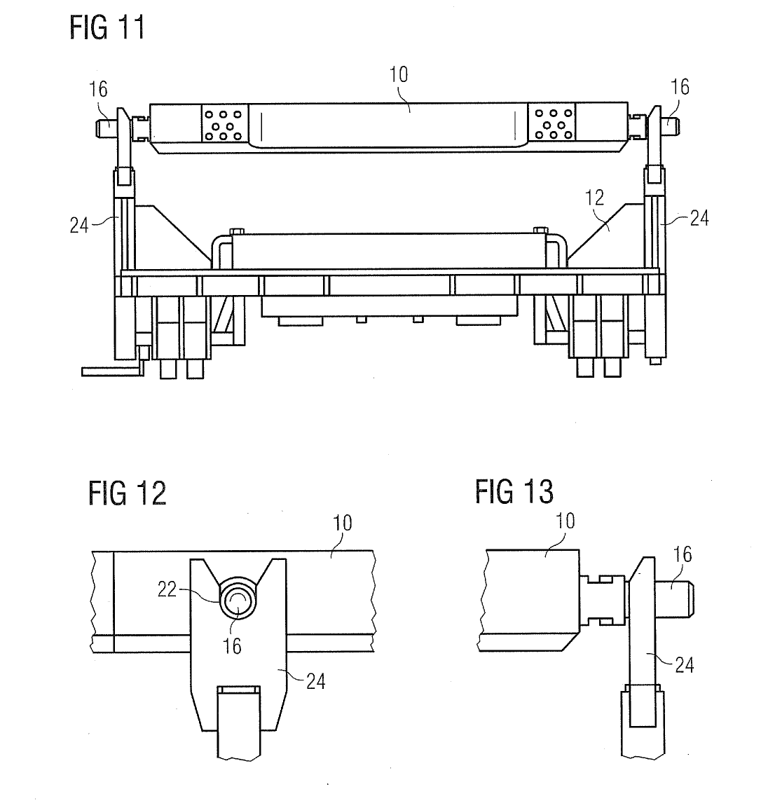

FIG. 11 shows a front view of a wagon 12 on which a yaw bedplate 10 is positioned. The wagon 12 comprises a plurality of aims including a cradle or fork portion 24 on which the pins 16 are positioned. The arms or cradle elements 24 support the yaw bedplate 10 via the pins 16.

FIGS. 12 and 13 show more details of the aims of the wagon 12. Each arm comprises one fork or cradle element 24 in which one pin 16 that is mounted to the yaw bedplate 10 is positioned. The fork element 24 comprises an essentially V-shaped upper portion in order to center a pin 16 with respect to the aim. A lower portion 22 of the cradle element 24 comprises an essentially U-shaped portion in order to grip the pin 16 and thus the yaw bedplate 10 in its position such that the yaw bedplate 10 is arranged at a more or less known and reproducible position with respect to a working machine.

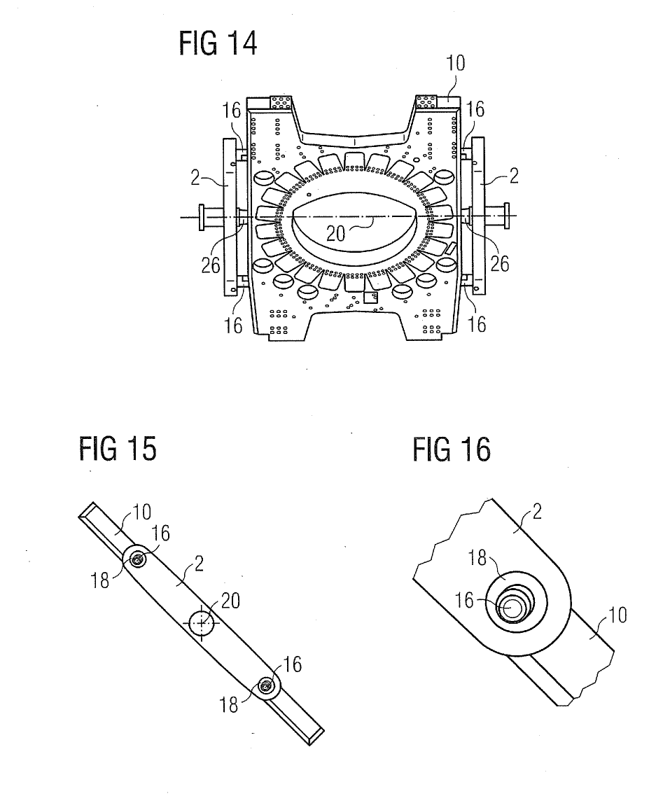

FIG. 14 shows further details of the process for turning the yaw bedplate 10. The beams 2 engage the pins 16 in order to grip the yaw bedplate 10. Optional spacers 26 ensuring that the beams 2 are positioned in the correct manner with respect to the yaw bedplate 10 are arranged on the beams. The spacer 26 may comprise at its end portion a sensor (not shown) indicating the control unit 8 (see FIG. 2) that the spacer 26 contacts the bedplate 10. FIG. 14 shows the yaw bedplate 10 in a state in which it was rotated approximately 45° about the horizontal turning axis 20.

FIGS. 15 and 16 show further details of the interaction of the pins 16 and openings 18 during rotating the yaw bedplate 10. Also FIGS. 15 and 16 show the yaw bedplate 10 and the beam 2 in a state after the yaw bedplate has been rotated approximately 45°. The pins 16 are arranged in the openings 18 of the beam 2. FIG. 16 shows that the pin 16 can move slightly within the opening 18, since the pin 16 has a smaller diameter than the opening 18 and the opening 18 has an oval shape. Thereby, tolerances can be accommodated.

The present invention provides a wind turbine component handling apparatus that can rotate safely heavy and bulky components of a wind turbine during manufacturing the same. The inventive wind turbine component turning apparatus does not require in an automatic operation mode any interaction with the operator as required by a crane-based system. The wind turbine component apparatus can be operated automatically. Further, the inventive wind turbine component turning system fulfils higher safety standards.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. A “unit” or “module” can comprise a number of units or modules, unless otherwise stated.

1.-14. (canceled)

15. A wind turbine component handling apparatus for rotating a wind turbine component, comprising:
a docking device configured to be essentially horizontally movable relative to a wind turbine component and to grip the wind turbine component;
a lifting device configured to essentially vertically lift the wind turbine component; and
a turning device configured to rotate the wind turbine component essentially about a horizontal axis.

16. The wind turbine component handling apparatus according to claim 15, further comprising:
a controller configured
to instruct the docking device to move essentially horizontally relative to the wind turbine component and to grip the wind turbine component,
to instruct the lifting device to lift the wind turbine component essentially vertically in an upward direction, and
to instruct the turning device to rotate the wind turbine component essentially about the horizontal axis.

17. The wind turbine component handling apparatus according to claim 15, wherein the docking device comprises two beams arranged on opposite sides of the wind turbine component, each beam having at least one engaging portion adapted to engage a complementary engaging portion of the wind turbine component or of an auxiliary structure coupled to the wind turbine component.

18. The wind turbine component handling apparatus according to claim 17, wherein the engaging portion is formed by an opening having an oval shape.

19. The wind turbine component handling apparatus according to claim 15, wherein the turning device rotates the docking device and the wind turbine component coupled thereto essentially about a horizontal axis.

20. The wind turbine component handling apparatus according to claim 15, wherein the lifting device lifts the docking device and the wind turbine component coupled thereto essentially in a vertical direction.

21. The wind turbine component handling apparatus according to claim 17, wherein each beam comprises at least two openings, wherein each opening engages a pin coupled to the wind turbine component in order to grip the wind turbine component in a fixed position with respect to the docking device.

22. The wind turbine component handling apparatus according to claim 17, wherein each beam comprises at least one spacer arranged on a side wall of the beam facing the wind turbine component.

23. The wind turbine component handling apparatus according to claim 15, configured to rotate a yaw bedplate.

24. A wind turbine manufacturing system, comprising:
a wind turbine component handling apparatus comprising:
a docking device configured to be essentially horizontally movable relative to a wind turbine component and to grip the wind turbine component;
a lifting device configured to essentially vertically lift the wind turbine component; and
a turning device configured to rotate the wind turbine component essentially about a horizontal axis; and
a support apparatus having at least one cradle element, wherein an auxiliary structure is positioned in the at least one cradle element, and wherein the auxiliary structure is coupled to the wind turbine component.

25. The wind turbine manufacturing system according to claim 24, wherein the support apparatus is movable.

26. A method for handling a wind turbine component, comprising:
gripping a wind turbine component by a docking device;
lifting the wind turbine component by a lifting device; and
rotating the wind turbine component by a turning device.

27. The method for handling a wind turbine component according to claim 26, further comprising:
mounting a plurality of pins to the wind turbine component; and
positioning the wind turbine component at a support apparatus such that each pin rests in a cradle element of the support apparatus.

28. The method for handling a wind turbine component according to claim 27, wherein the gripping includes moving the docking device essentially in a horizontal direction such that openings in the docking device engage the pins mounted to the wind turbine component.

29. The method for handling a wind turbine component according to claim 27, wherein the lifting includes lifting the docking device, and wherein the wind turbine component is lifted by the pins mounted to the wind turbine component.

30. The method for handling a wind turbine component according to claim 27, wherein the rotating includes rotating the docking device essentially about a horizontal axis, and wherein the wind turbine component is turned about the horizontal axis by the pins mounted to the wind turbine component.

31. The method for handling a wind turbine component according to claim 27, further comprising:
lowering the docking device until the pins mounted to the wind turbine component rest in the cradle elements of the support apparatus.

32. The method according to claim 26, wherein the component to be turned is a yaw bedplate.
